(19) United States
(12) Patent Application Publication
(10) Pub. No.: US 2013/0247137 A1
(43) Pub. Date: Sep. 19, 2013

(54) METHODS AND SYSTEMS FOR AUTOMATICALLY CONFIGURING AND RE-CONFIGURING ELECTRONIC SECURITY INTERFACES

(71) Applicants: Rohit Raj Puri, Salt Lake City, UT (US); Colin Puri, South Jordan, UT (US)

(72) Inventors: Rohit Raj Puri, Salt Lake City, UT (US); Colin Puri, South Jordan, UT (US)

(21) Appl. No.: 13/731,094

(22) Filed: Dec. 30, 2012

Related U.S. Application Data
(60) Provisional application No. 61/582,168, filed on Dec. 30, 2011.

(51) Int. Cl. H04L 29/06

(52) U.S. Cl. CPC H04L 63/20
USPC 726/1

(57) ABSTRACT

A scalable and flexible system and method for automatically configuring and re-configuring electronic security interfaces comprising video, audio, wireless hardware and software capable of capturing video and audio designed to be a true “plug-n-play” for an end-user. The system is configured to incorporate almost any type of camera, battery technology, storage device, wifi or cellular technology, microphone and provides access to the web in real-time to add applications, for example, facial recognition web services, real-time comparing of any previously identified and stored object etc. In addition, the system and method is capable of taking inputs of most custom user-deployment application requirement and generating a set of hardware to fulfill a user's particular requirements.

### PRIORITY CLAIM

The present invention claims priority to and the benefit of U.S. Provisional Application No. 61/582,168, entitled “System And Method For Intelligent And Dynamic Configuration Of Multi Media Hardware And Software Interface,” filed on Dec. 30, 2011 by Inventors Rohit Raj Puri and Colin Puri, the contents of which are incorporated herein by reference.

### BACKGROUND

The present disclosure relates to control systems and electronic interfaces for security operations. In particular, the present disclosure relates to systems and methods for automatically facilitating intelligent and dynamic configurations for security interfaces, which are designed to be re-configured more than once.

Typically, the process of designing and creating or constructing security and control systems includes three basic segments. A first segment involves considering product manufacturers and their products, for example, a camera, a video recorder, software, hard disk drive, battery or router etc. A second segment involves a skilled integrator considering a particular customer's requirements and designing and building a custom system for the particular application desired by the customer. Depending upon the area that must be secured or the complexity of the security system desired by a customer, a project may be small or very large. A third segment involves customers and users, who in turn must look at the features, performance, scalability, flexibility, and most importantly, the costs involved in constructing and deploying the systems they desire.

Challenges typically facing an integrator and customers alike are that they cannot envision the scope of a project beyond current requirements. Typically, customer needs change with expansion. In those instances, customers cannot simply expand their current security systems, and must resort to replacing them, suffering significant financial loss. Therefore, current methods do not facilitate any flexibility for integrators and customers.

Moreover, for customers, it is a daunting task, to select appropriate products, as there are over 4000 suppliers of cameras, alone, which is just one critical component in creating a security system. The task is further complicated with dynamic pricing, with which customers must keep abreast. Customers may defer final choices to myriad integrators and distributors located around the world, who may either integrate or supply products from manufacturers to end customers, either directly or through a sub-contractor. These integrators and distributors often have their own preferences, imposing products from manufacturers with whom they have formed relationships, often to the detriment of the customer. Hence, the integrators and distributors may not offer the best solution to a customer or even worse, may try and force their preferences to fit a particular customer's application. In the end, it is the customers who suffer, as they may not receive the optimum solution there is, or perhaps, they may pay a lot of money for inadequate systems that they may only use for a short while.

Further, in most instances, although the requirements of a company that desires a security system for a parking lot, may be no different than that of a company that desires a security system for an entire parking structure, the former customer may incur greater charges by using an integrator as compared to a customer who may receive satisfactory pricing due to the quantity volume. Besides, there are many customers who have simple requirements that are not adequately addressed by integrators or distributors who typically seek larger scale applications.

Yet another consideration is that security and other video and audio monitoring applications are varied and the deployment conditions from one to another are totally different. Deployments of various products may also vary drastically, from a trade-show environment where a variable zoom lens may simply be required to focus on an attendee, to an oil well in a sub-zero environment, where a fixed lens may be required with the added ability to withstand the extreme temperature.

Customers require ultimate flexibility to select the right camera, audio equipment, battery technology, router and message delivery system etc., for their particular applications. These requirements may change short term and thus, the investment is lost as customers have to re-invest in new systems.

With the ongoing trends and growth in security requirements and current feelings toward integrators and distributors, it would certainly be beneficial to find more flexible methods and modules that facilitate intelligent and dynamic configurations for security interfaces.

### SUMMARY

Any deficiencies or limitations of existing technologies are overcome, at least in part, by providing technology including systems and methods for facilitating intelligent and dynamic configurations for security interfaces. It is desirable to have systems that are easily configurable by end users or customers using hardware and software solutions. In one implementation, a software-library-guided menu allows a user to configure equipment, which includes, but is not limited to, video cameras (analog and digital), external microphones, rechargeable batteries, routers, wifi, near-field communications (NFC), radio-frequency identification (RFID), cellular network, hard-disk drives, network video recorders, ZigBee-based equipment, internal database for pictures and personal identification and barcodes.

In one implementation, it is desirable to have systems that are configured to provide end user inputs with a set of requirements for audio and video operations using a software wizard, whereby the systems can provide an output suggesting a set of equipment types that potentially fits those requirements. As one example, considering a setup for a trade show, a user may input the size of the booth or the surveillance area, indicate a desired requirement or ability to zoom on a person (to magnify an image of the person to a desired amount) and indicate a desired amount of time for which voice at that location should be recorded. With these indications that are input, the system is configured to process the input and output a suggested list of cameras and microphones that fit the requirements indicated by the user.

In one implementation, it is desirable to have a system that is scalable and flexible in nature, so an end user can easily configure the system for today's requirements at a lower cost, but as the requirements change and become more complex at a later date, the initial investment is not lost, as the system is configured to allow re-use of the same hardware. As one example where a customer desires to monitor a backyard, configuring a system with a single camera to record the activity in the backyard. In the event the customer's requirements change, to not only monitoring the same backyard, but also to recording audio and then remotely sending a text message in case an alarm is detected, the same hardware may be easily used with addition of the new pieces, for example, a microphone and router with cellular capability. The system may be easily re-configured and programmed with including the new additional pieces, so that it is operating quickly and at reduced cost.

In some embodiments, this technology includes a method of configuring a system using at least one computing device, for monitoring a location, including, determining parameters of the location; classifying the parameters, wherein the parameters define requirements for at least one or more of audio, video, communication, storage, recording times, and energy devices; cross-reference the parameters with a predefined database of hardware devices to selectively determine suggested hardware devices that meet the requirements; suggest software configurations based on the requirements; and enable user access to software configurations and the hardware devices that meet the requirements, to enable modifications to either the hardware devices and the software configurations.

In some embodiments, this technology includes a system, comprising: a set of devices for security monitoring, dynamically configurable for different applications and scales, further comprising: one or more video cameras configured to capture images of designated areas or entities; an audio input and output to interface to a microphone to capture and reproduce sounds of the designated areas or entities; communications devices including at least one or more of a group of WiFi, Cellular, Zigbee, Near Field Communication (NFC), Radio Frequency Identification (RFID) wired and wireless routers, configured to transfer information from the system to a user or to other external systems and external users; a battery unit configured to drive the system when power from an outlet is not available; a barcode reader to receive input from a user; and a storage device to record images and sounds and store device configurations.

### BRIEF DESCRIPTION OF THE DRAWINGS

The present disclosure is illustrated by way of example, and not by way of limitation, in the figures of the accompanying drawings, in which like reference numerals are used to refer to similar elements.

FIG. 1 is a high-level block diagram illustrating some embodiments of system architecture including a dynamically configurable and re-configurable interface module for automatically facilitating intelligent and dynamic configurations for security interfaces in applications desired by an end user.

FIG. 2 is a block diagram of the hardware components of the dynamically configurable and re-configurable interface module shown in FIG. 1.

FIG. 3 is a block diagram of the software components of the dynamically configurable and re-configurable interface module shown in FIG. 1.

FIG. 4 is a block diagram illustrating the software components in use in an intelligence mode, where only the requirements may be specified by a user, which are automatically reduced or translated by an algorithm integration module 403 into different parameters enabling the integration module 421 to easily select appropriate modules available for the user.

FIG. 5 is a block diagram illustrating the software components of an alternative embodiment where a user knows the parameters and wants to use the system to find modules that are available on the existing database.

FIG. 6 is a flow chart illustrating an example overall process by which the integration module 421 integrates all the modules for a particular application into a unified process for access.

FIGS. 7A-7E are flow charts illustrating an example flow of operations by the integration module 421 to integrate all application modules into a unified process for access.

FIG. 8 illustrates an example overall process by which the algorithm integration module 403 integrates a setup guidance module 423 within the dynamically configurable and re-configurable interface module to provide the intelligence to break it down into different parameters required by the integration module 421.

FIGS. 9A-9B illustrate an example flow chart of the operations by which the algorithm integration module 403 integrates with the setup guidance module 423 providing the intelligence to break into different parameters required by the integration module 421.

FIG. 10 is an example implementation of the configurable and re-configurable electronic security interface module.

FIG. 11 is another example implementation of the configurable and re-configurable electronic security interface module.

### DETAILED DESCRIPTION

In some embodiments, this technology is directed to systems and methods for facilitating intelligent and dynamic configurations for security interfaces.

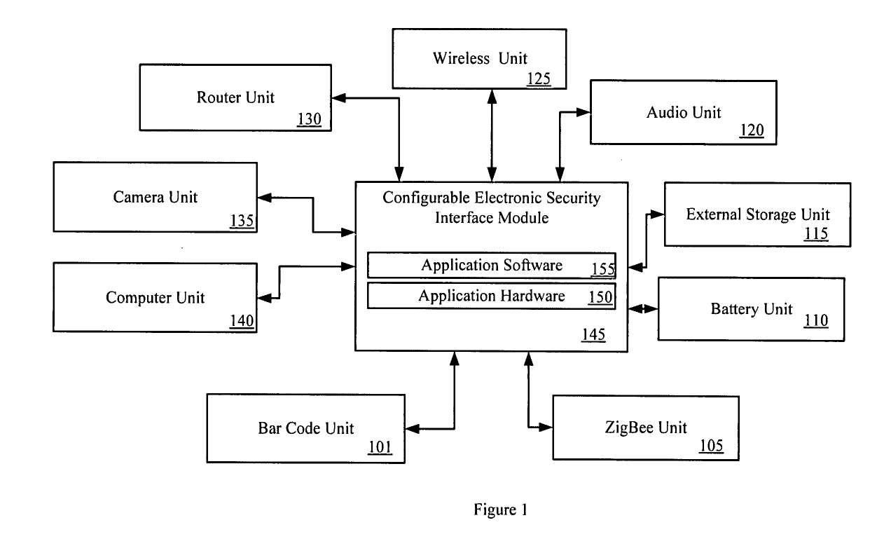

As shown in FIG. 1, the system illustrated generally by reference numeral 100 includes a camera 135, which may be a video camera, either analog or digital, which is typically used for electronic motion picture and surveillance. The camera 135 may be configured for displaying real-time images to a screen and recording these images on a suitable storage device. The camera 135 may be programmed using any device capable of accessing the web, via a web browser, similar but not limited to, a computer, a smartphone or table, either of which may be accessed either through a router 130 or any device capable of routing data packets between local and wide-area computer networks (“WAN”) or directly using a cellular connection. The router 130 may be one that operates via a wireless (“Wi-Fi”) unit 125, which may be any unit comprising a mechanism to wirelessly control electronic devices, for example, a mobile phone, a device capable of making and receiving calls over a radio link and communicating with a computer, a smartphone or tablet. It should be recognized that communications may be either wirelessly or via wired configurations. The Wi-Fi or cellular (WAN connection) communicates with the camera via a web browser to dynamically control and change the parameters of the camera 135.

The Wi-Fi or cellular connection may be one configured to transmit a text message or email to an external web-based device or a mobile device, for example, a smart phone or tablet.

The camera 135 may use an auto-zoom feature to focus and capture details of facial features or any image of concern or interest to a user, within the parameters defined by the camera specification. The camera 135 may be configured to automatically switch from a well-illuminated area to a low-illuminated area automatically in order to maintain the quality and integrity of the video and image.

The camera 135 may be configured to store hours of video footage using an external storage device, for example, a secure digital (“SD”) or micro-SD card 115, a non-volatile memory format device developed by the SD Card Association (“SDA”) and used in portable devices, using a multitude of standard video compression algorithms. Compressed files may be extracted by the user and copied to an external computer 140, a programmable device capable of sequentially and automatically carrying out a sequence of arithmetic or logical operations, or automatically storing the compressed audio and video information to an external storage unit 115, for example, to a hard disk drive or networked video recorder.

The camera 135 takes an external audio input 120 using a fixed microphone, for example, a shotgun or any wireless lavalier microphone. The camera 135 may have an internal amplifier for enhancing the external microphone and amplifying the quality of any sound that is recorded. The captured audio may be mixed with the video and overlaid with custom text.

In some implementations, a barcode 101, or other optical machine readable representation of data, showing the data about the object, where it attaches, captures information on the subject, either by scanning directly or after the process, by using a software algorithm to retrieve the information from a database.

Using a Zigbee interface 105, a wireless network may be used, for appliance and industrial control conforming to the IEEE 802.15.4 wireless standard for low power and data rates. The re-configurable electronic security interface module 145 is controlled and programmed using any device capable of communicating using a Zigbee interface, thereby saving power and cost.

For portability and remote applications, a battery 110, may be used, including one or more electrochemical cells configured for converting stored chemical energy into electrical energy. Module controls may store and charge a variety of battery cells including, but not limited to, Nickel Cadmium (NiCd), Nickel Zinc (NiZn), Nickel Metal Hydride (NiMH), and Lithium-Ion(Li-ion) cells.

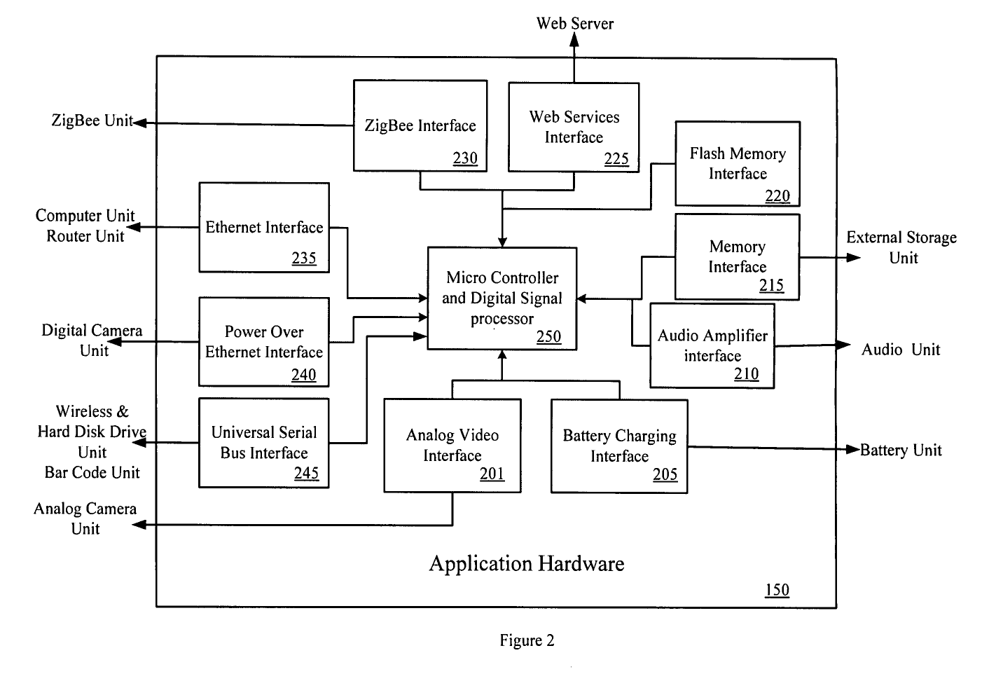

Referring now to FIG. 2, a micro-controller 250 compiles the code used with one or more computers configured to run a variety of operating systems including, but not limited to Windows, Linux or the Apple Operating system. A DSP (Digital Signal Processor) 250 analyzes the video and audio enabling the use of the compression algorithm to reduce the file size, including but not limited to H264.1, MPEG4, or MJPEG etc., for purposes of storing the video.

A flash memory interface 220 is configured for internal use and for accessing external memory banks. A Secure Digital (“SD”) card 215 interface may boot the device 250 for temporary storage of video and audio files. An audio amplifier and receiver interface 210 accepts a variety of external microphones, with or without amplification, and provides the output to the camera 135. A battery charging circuit 205 is configured to charge re-chargeable batteries that are configurable, examples of which are Nickel Cadmium (“NiCd”), Nickel Zinc (“NiZn”), Nickel Metal Hydride (“NiMH”), and Lithium-Ion (“Li-ion”) cells. Video signals from analog cameras 201 may be converted to digital video to ensure compatibility with current extensive installations. Universal Serial Bus (“USB”) hub 245 connects WiFi, mobile networks, external hard disk drives, network video recorders, and barcode readers. Power-Over-Ethernet (“POE”) interface 250 connects any digital IP camera capable to be powered by a POE interface. An Ethernet interface 235 conforming to IEEE 802.3 standard may be used to connect to an external computer and routers. The Zigbee interface 230 may connect to devices conforming to the IEEE 802.15.4 wireless standard. A web services interface 225 connects to various devices, including but not limited to computers, smartphones, tablets etc., and those devices capable of connecting to the web.

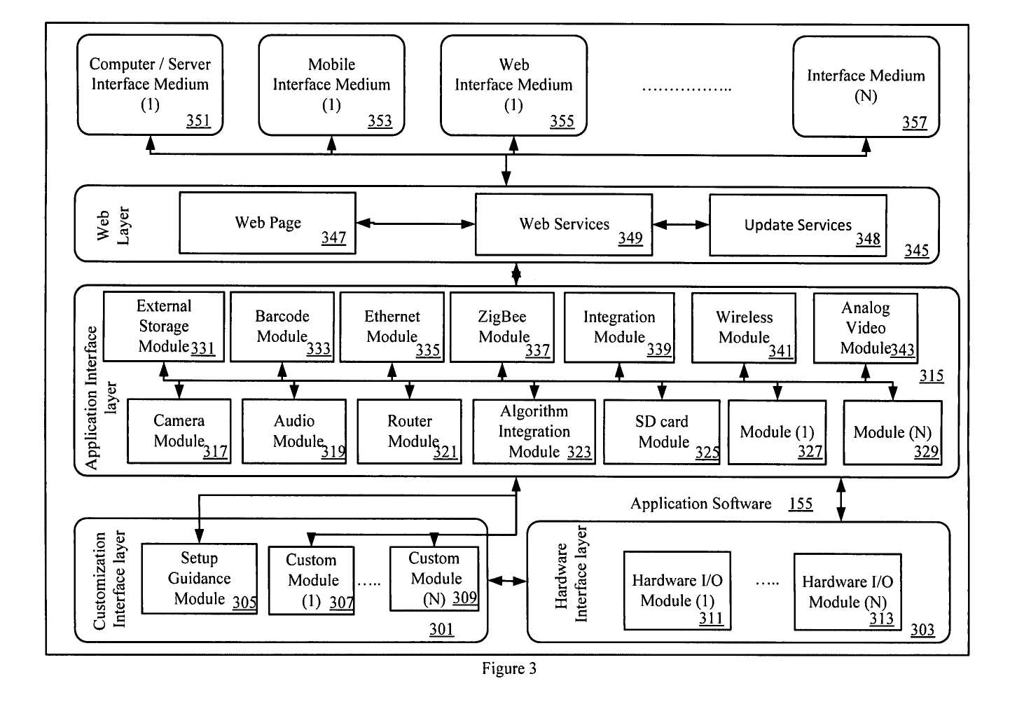

Referring now to FIG. 3, the software integration and the interaction of the different layers and the intelligence using a proprietary algorithm is described. A first layer, web layer 345 acts as the external interface to applications for any external devices that may want access to or obtain data from the software and hardware. A web page module 347 serves up content in a format designed for consumption for external browsers. A web services module 349 serves up content in a format designed for consumption by external devices. An update services module 348 provides services, and using these services, the re-configurable electronic security system may be remotely updated with the latest revision of software. The system is configured to be remotely maintained and receive troubleshooting instructions over an internet connection.

An application interface layer 315 provides a mechanism for gaining access to the collection of software modules that interface with the hardware and provide standard functionality. This layer interacts with the customization interface layer and all modules contained within this interface, with the hardware interface layer configured to gain access to hardware resources. An integration module 339 serves to integrate all application modules into a unified method of access and operation. An algorithm integration module 323 is configured to breaks into different parameters, using an intelligence algorithm, as required by the integration module, to select the appropriate modules available to the user/customer. A router module 321 interacts with a corresponding ethernet interface 235 in the hardware interface layer. This module interacts with the router hardware and computes statistics and other runtime information as well as provides administrative functionality of the router to other modules. A Zigbee module 337 interacts with the corresponding Zigbee interface 230 in the hardware interface layer. This module interacts with the Zigbee hardware, stack, computes statistics, and other runtime information as well as provides administrative functionality of the Zigbee to other modules (e.g., wireless settings).

An external storage module 331 interacts with the corresponding memory interface 215 of the hardware interface layer. It provides functionality for calculating and storing runtime statistics, file management, and administrative purposes. A barcode module 333 interacts with the corresponding universal serial bus interface 245 in the hardware interface layer. This provides functionality to determine types of barcodes, and decoding barcodes. An ethernet module 335 interacts with the corresponding ethernet interface 235 in the hardware interface layer. This provides functionality for monitoring the network, configuring network settings, etc. The SD card module 325 interacts with the corresponding flash memory interface 220 in the hardware interface layer. This provides functionality for calculating runtime statistics, file management, and administrative purposes that are targeted to how an SD card is utilized and operated. An audio module 319 interacts with the corresponding audio amplifier interface 210 in the hardware interface layer. It provides functionality for calculating runtime statistics, signal acquisition, signal monitoring, and audio configuration (gain, volume, etc.).*

An analog video module 343 interacts with a corresponding analog video interface 201. This module acquires information from the hardware interface module to compute runtime statistics, create or modify runtime data, provide video adjustments, and perform administrative tasks when interacting with the analog video device through the hardware layer. Module (1), indicated by reference numeral 327, through Module (N), indicated by reference numeral 329 designate that additional modules can be added as necessary and that there is no limit on the number of modules that may be added or integrated. These may be for the Battery Module, USB module etc. Another layer customization interface layer 303, is configured to allow access to the collection of customized software modules that interface with the hardware and other modules. This layer interacts with the hardware interface layer to gain access to hardware resources. A setup guidance module 305 acts as a setup “Wizard” with proprietary algorithms to configure the operating environment for an overall larger device. As one example, it consumes information, for example, a desired area of operation, a number of microphones, the type of microphones, the placement of microphones, a number of monitoring units, a network configuration, a library of configured hardware, recognized and auto-detected hardware that is connected, etc. It returns a suggestion of a desired configuration setup that best utilizes the existing hardware and software. Using the proprietary algorithm, the setup guidance module 305 is capable of returning a set of applicable hardware based on user defined applications.

group of modules, including a custom module (1), indicated by reference numeral 307 through custom module (N), indicated by reference numeral 309 denotes the capability of the overall device to accept customized “plug-ins” that may be utilized with the device to perform additional functionality. The custom modules may interact with other modules in any layer.

A hardware interface layer 303 provides input and output to all hardware devices connected to the host. A group of hardware modules including a hardware module 1, indicated by reference numeral 311, through hardware module (n), indicated by reference numeral 313, provides a framework of hardware for every piece of hardware that is connected. It should be recognized that additional hardware modules may be added or removed as new hardware is added or removed.

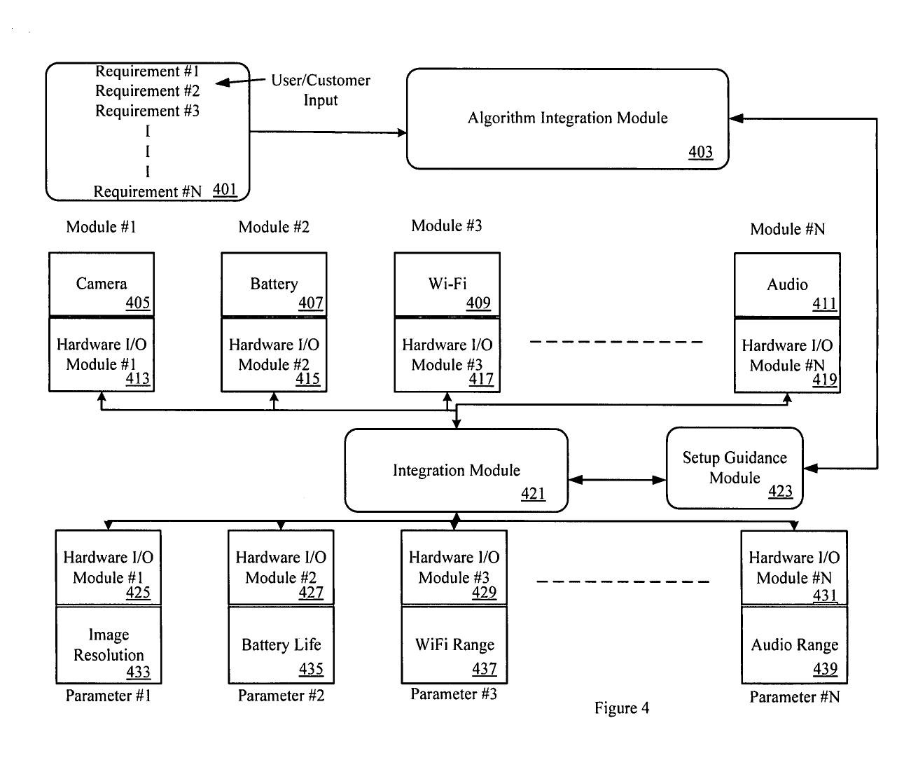

Referring now to FIG. 4, the intelligence-driven module is described in further detail. A series of requirements, #1 through #N, are illustrated generally by reference numeral 401. An algorithm integration module 403 is illustrated with a camera 405, a battery 407, a Wi-Fi 409, an audio 411, a hardware I/O Module #1, indicated by reference numeral 413, a hardware I/O module #2, indicated by reference numeral 415, a hardware I/O module #3, indicated by reference numeral 417, a hardware I/O Module #N, indicated by reference numeral 419, an integration module indicated by reference numeral 421, a setup guidance module 423, a hardware I/O Module #1 425, a hardware I/O module #2 427, a hardware I/O module #3 429, a hardware I/O module #N 431, an image resolution 433, a battery life 435, a Wi-Fi range 437, and an audio range 439,

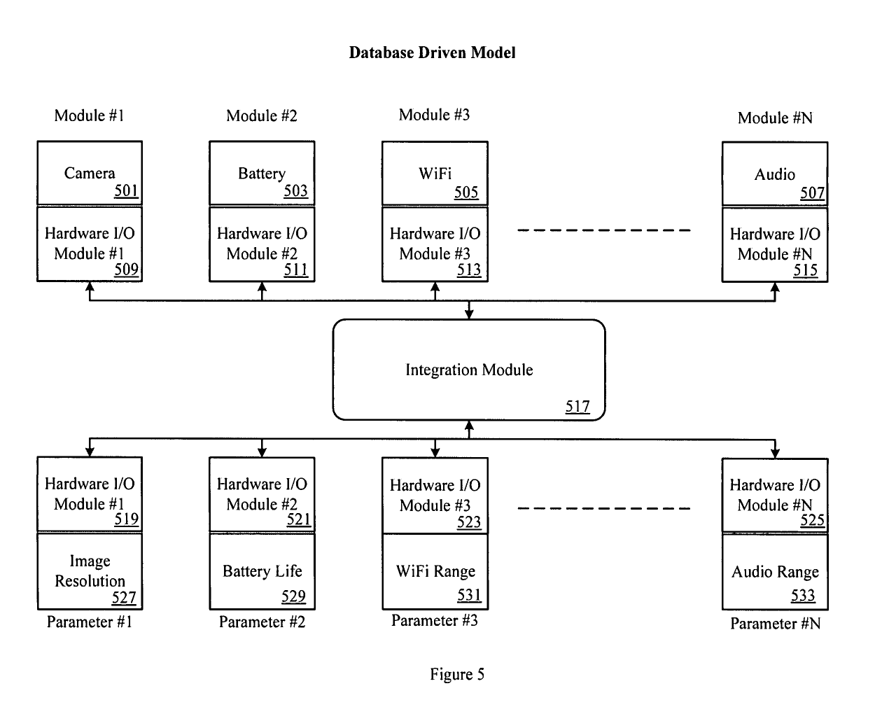

FIG. 5 illustrates a database-driven module also illustrating a camera 501, a battery 503, a Wi-Fi 505, an audio 507, a hardware I/O module #1, indicated by reference numeral 509, a hardware I/O module #2, indicated by reference numeral 511, a hardware I/O Module #3, indicated by reference numeral 513, a hardware I/O module #N, indicated by reference numeral 515, an integration module 517, a hardware I/O module #1, indicated by reference numeral 519, a hardware I/O module #2, indicated by reference numeral 521, a hardware I/O module #3, indicated by reference numeral 523, a hardware I/O Module #N, indicated by reference numeral 525, an image resolution unit, indicated by reference numeral 527, battery life 529, Wi-Fi Range 531, and audio range 533.

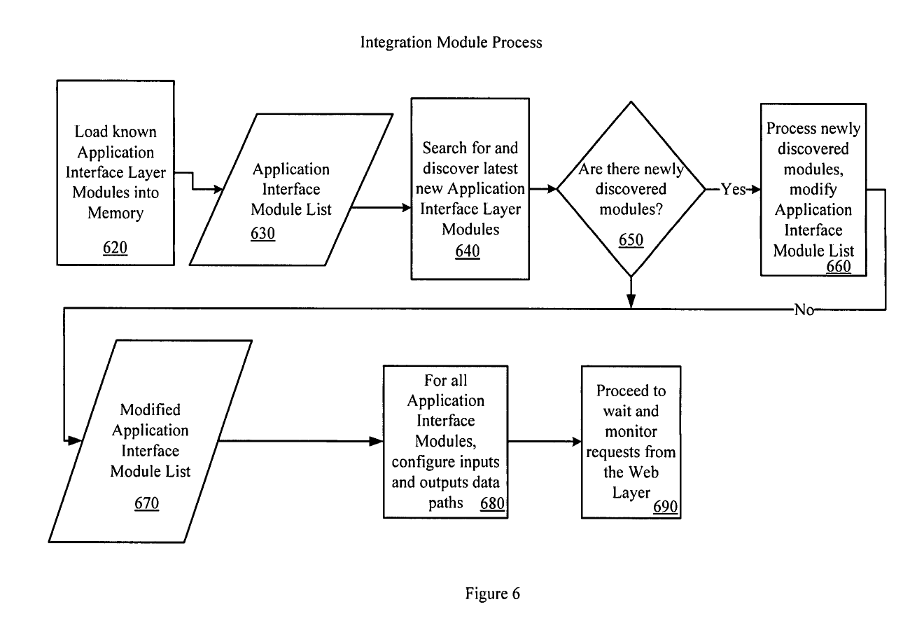

FIG. 6 illustrates an example method of operations 600 performed by the integration module. The method begins at block 620, which includes one or more operations for loading known application interface layer modules into memory 620. From there, the method 600 proceeds to the next block 630 which includes one or more operations for compiling an application interface module list. The method 600 proceeds to the next block 640, which includes one or more operations for searching for and discovering the latest and new application interface layer modules. The method 600 proceeds to the next block 650 that includes one or more operations to query if there are any newly discovered modules. The method 600 proceeds to the next block 660, which includes one or more operations for processing newly discovered modules to modify the application interface module list 660. The method 600 proceeds to the next block 670, which includes one or more operations for compiling a modified application interface module list. The method 600 proceeds to the next block 680, including one or more operations for configuring input and output data paths for all the application interface modules. The method 600 proceeds to the next block 690, including one or more operations, that proceed to wait and monitor requests from the web layer.

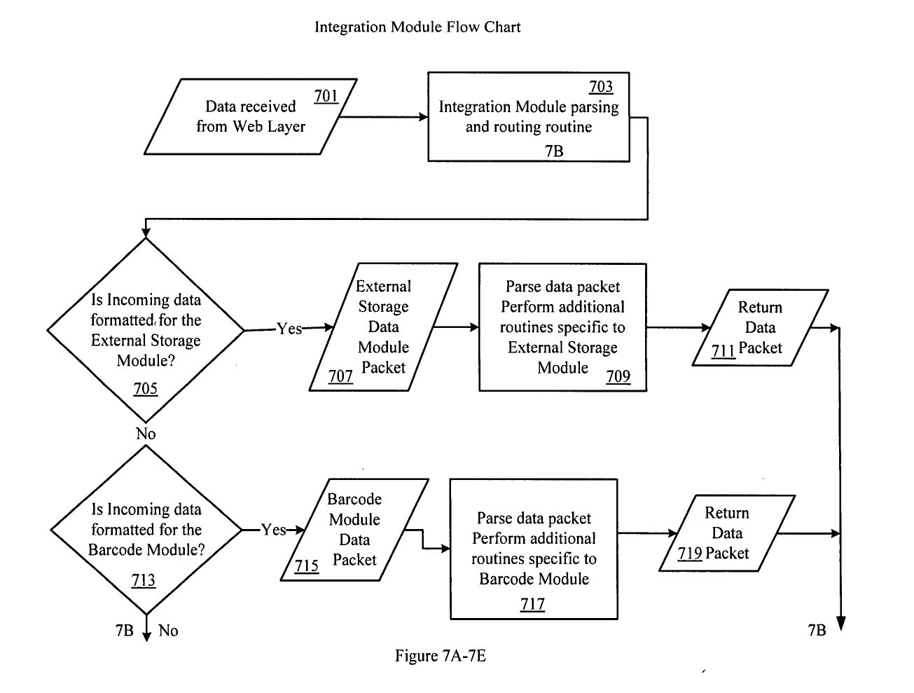

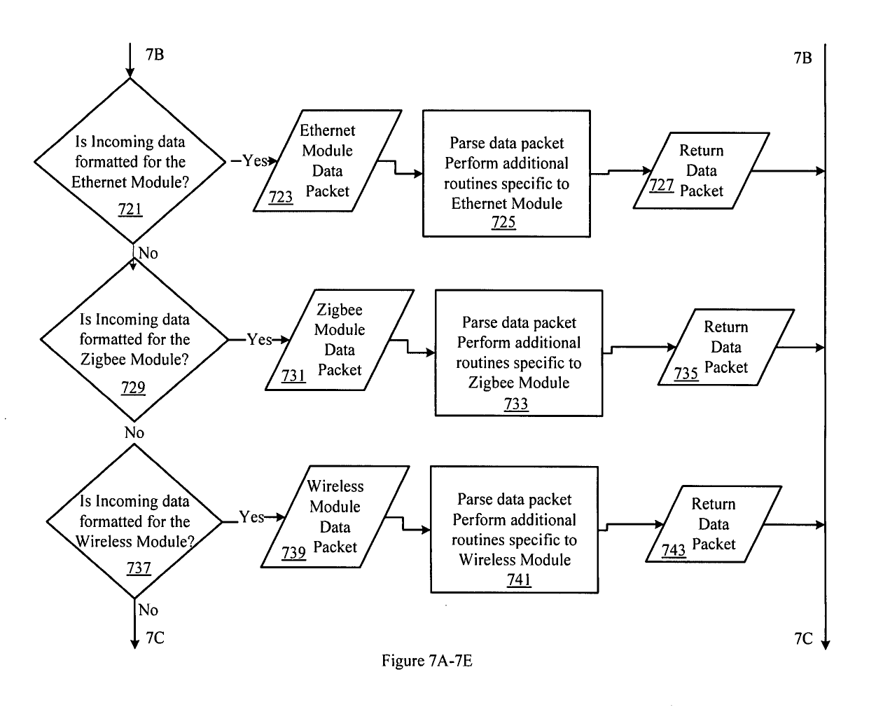

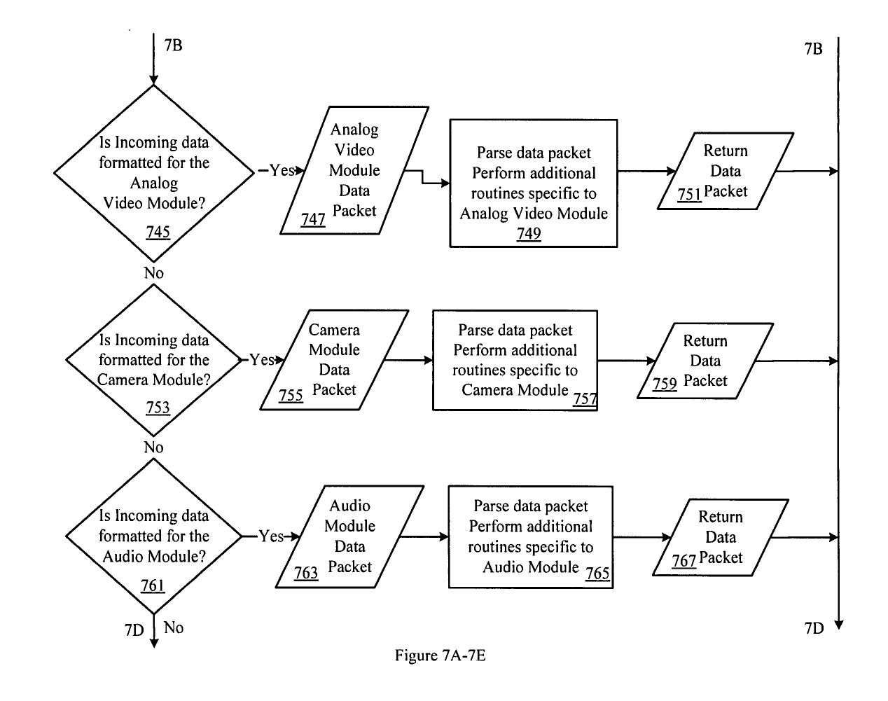

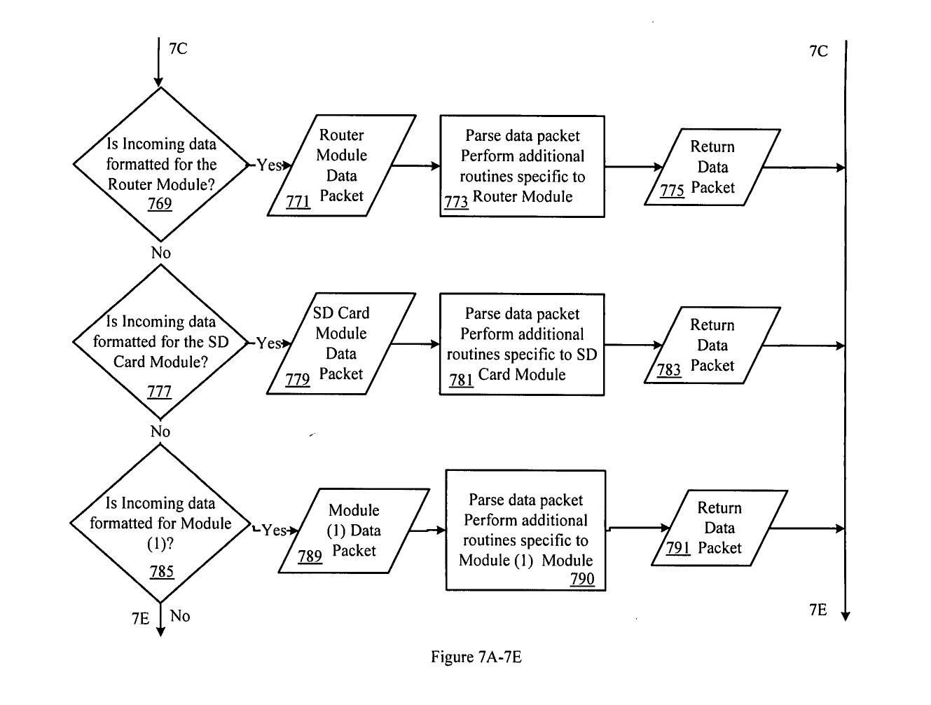

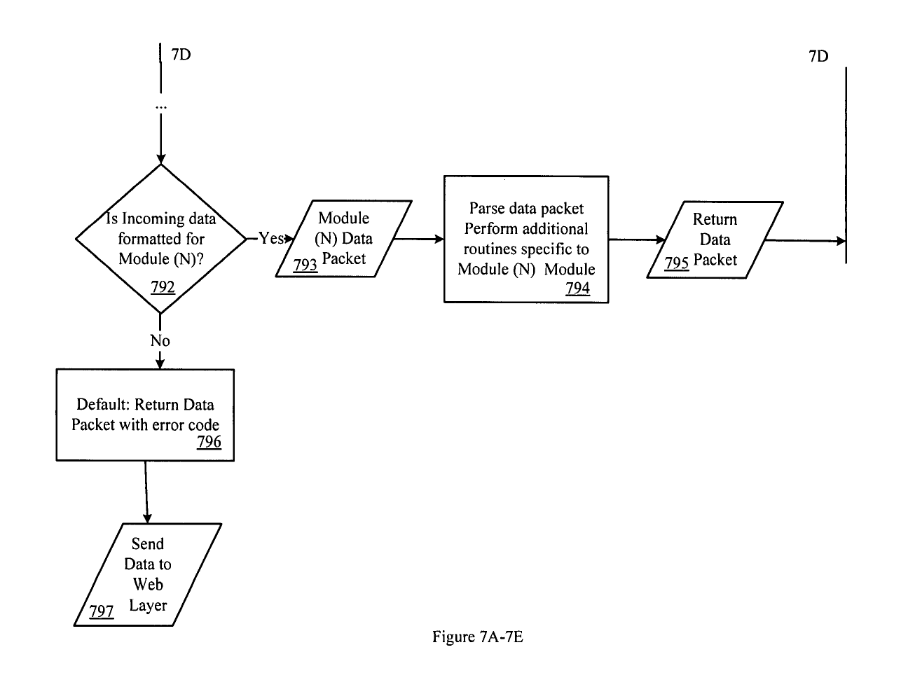

FIGS. 7A-7E illustrate a flow chart of the method indicated generally by reference numeral 700 including operations performed by the integration module. The method 700 begins and proceeds to a block 701, which receives data from the web layer. The method 700 proceeds to the next block 703, that includes one or more operations for parsing and routing routines. The method 700 proceeds to the next block 705, which includes one or more operations, for determining if incoming data is formatted for the external storage module. The method 700 proceeds to block 707, which includes one or more operations for receiving external storage data module packets. The method 700 proceeds to the next block 709, which includes one or more operations, for parsing data packets, by performing additional routines specific to the external storage module. The method 700 proceeds to the next block 711, which includes one or more operations for returning data packets. The method 700 proceeds to the next block 713, which includes one or more operations, for determining if incoming data is formatted for the barcode module. The method 700 proceeds to the next block 715 that includes one or more operations for barcoding module packets. The method 700 proceeds to the next block 717 that includes one or more operations for parsing data packets by performing additional routines specific to the barcode module. The method 700 proceeds to the next block 719 that includes one or more operations for returning data packets. The method 700 proceeds to the next block 721 that includes one or more operations for determining if incoming data is formatted for the Ethernet module. The method 700 proceeds to the next block 723, for including one or more operations for determining Ethernet module packets. The method 700 proceeds to the next block 725 that includes one or more operations for parsing data packets by performing additional routines specific to the Ethernet Module. The method 700 proceeds to the next block 727 that includes one or more operations for returning the data packets. The method 700 proceeds to the next block 729, which include one or more operations for determining if incoming data is properly formatted for the Zigbee Module. The method 700 proceeds to the next block 731, which include one or more operations for determining Zigbee module packets. The method 700 proceeds to the next block 733, which include one or more operations for parsing data packet. From there, the method 700 proceeds to the next block 733, which include one or more operations for performing additional routines specific to the Zigbee module.

The method 700 proceeds to the next block 735, which includes one or more operations for returning data packets. The method 700 proceeds to the next block 737, which include one or more operations for determining if incoming data is formatted for the Wireless Module. The method 700 proceeds to the next block 739, which include one or more operations for determining wireless module packets. The method 700 proceeds to the next block 741, which include one or more operations for parsing data packets. The method 700 proceeds to the next block 741, which include one or more operations for performing additional routines specific to the wireless module. The method 700 proceeds to the next block 743, which include one or more operations for receiving return data packets. The method proceeds to the next block 745, which includes one or more operations for determining if incoming data is formatted for analog video modules. The method 700 proceeds to the next block 747, which include one or more operations for determining analog video module packets. The method 700 proceeds to the next block 749, which include one or more operations for parsing data packets. The method 700 proceeds to the next block 751, which include one or more operations for performing additional routines specific to analog video modules. The method 700 proceeds to the next block 751, which include one or more operations for receiving data packets. The method 700 proceeds to the next block 753, which include one or more operations for determining if the incoming data is formatted for the camera module. The method 700 proceeds to the next block 755, which include one or more operations for determining camera module packets The method 700 proceeds to the next block 757, which include one or more operations for parsing data packets. The method 700 proceeds to the next block 759, which include one or more operations for performing additional routines specific to Camera Module and returning data packets. The method 700 proceeds to the next block 761, which include one or more operations for determining if incoming data is formatted for the audio module. The method 700 proceeds to the next block 763, which include one or more operations for determining audio module packets. The method 700 proceeds to the next block 765, which include one or more operations for parsing data packets by performing additional routines specific to the audio module. The method 700 proceeds to the next block 767, which include one or more operations for receiving return data packets. The method 700 proceeds to the next block 769, which include one or more operations for determining if incoming data is formatted for the router module. The method 700 proceeds to the next block 7771, which include one or more operations for receiving router module packets. The method 700 proceeds to the next block 773, which include one or more operations for parsing data packets by performing additional routines specific to the router module. The method 700 proceeds to the next block 775, which include one or more operations for receiving return data packets. The method 700 proceeds to the next block 777, which include one or more operations for determining if incoming data is formatted for the SD Card Module. The method 700 proceeds to the next block 779, which include one or more operations for receiving SD Card Module Packet. The method 700 proceeds to the next block 781, which include one or more operations for parsing data packets by performing additional routines specific to SD Card Module. The method 700 proceeds to the next block 783, which include one or more operations for receiving return data packets. The method 700 proceeds to the next block 785, which include one or more operations for determining if incoming data is formatted for Module (1). The method 700 proceeds to the next block 789, which include one or more operations for determining module (1) data packets. The method 700 proceeds to the next block 790, which include one or more operations for parsing data packets by performing additional routines specific to Module (1) through Module (790). The method 700 proceeds to the next block 791, which include one or more operations for receiving return data packets. The method 700 proceeds to the next block 792, which include one or more operations for determining if incoming data is formatted for Module (N). The method 700 proceeds to the next block 793, which include one or more operations for receiving Module (N) data packets. The method 700 proceeds to the next block 794, which include one or more operations for parsing data packets by performing additional routines specific to Module (N). The method 700 proceeds to the next block 795, which include one or more operations for receiving return data packets 795. The method 700 proceeds to the next block 796, which include one or more operations for determining a default and returning data packets with an error code. The method 700 proceeds to the next block 797, which include one or more operations for sending data to the web layer.

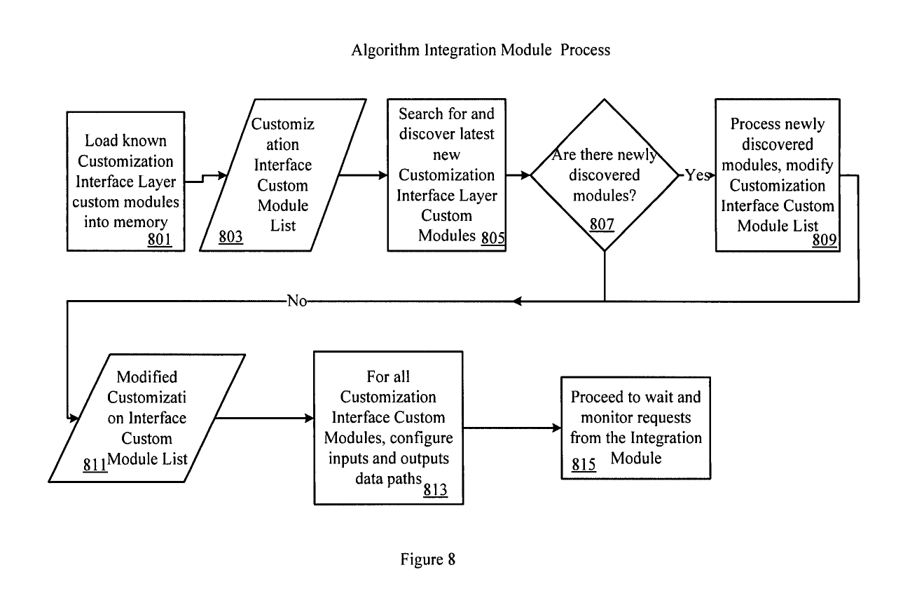

FIG. 8 illustrates a method 800 performed by the algorithm integration module. The method 800 begins at block 801, which include one or more operations for loading known customization interface layer custom modules into memory. The method 800 proceeds to the next block 803, which includes one or more operations for compiling a customization interface custom module list. The method 800 proceeds to the next block 805, which includes one or more operations for searching for and discovering latest new customization interface layer custom modules. The method 800 proceeds to the next block 807, which include one or more operations for determining if there are newly discovered modules. The method 800 proceeds to the next block 809, which include one or more operations for processing newly-discovered modules, and modifying customization interface custom module lists. The method 800 proceeds to the next block 811, which includes one or more operations for modifying customization interface custom module lists. The method 800 proceeds to the next block 813, which include one or more operations for configuring input and output data paths for all customization interface custom modules. The method 800 proceeds to the next block 815, which include one or more operations for implementing a waiting period while monitoring requests from the integration module.

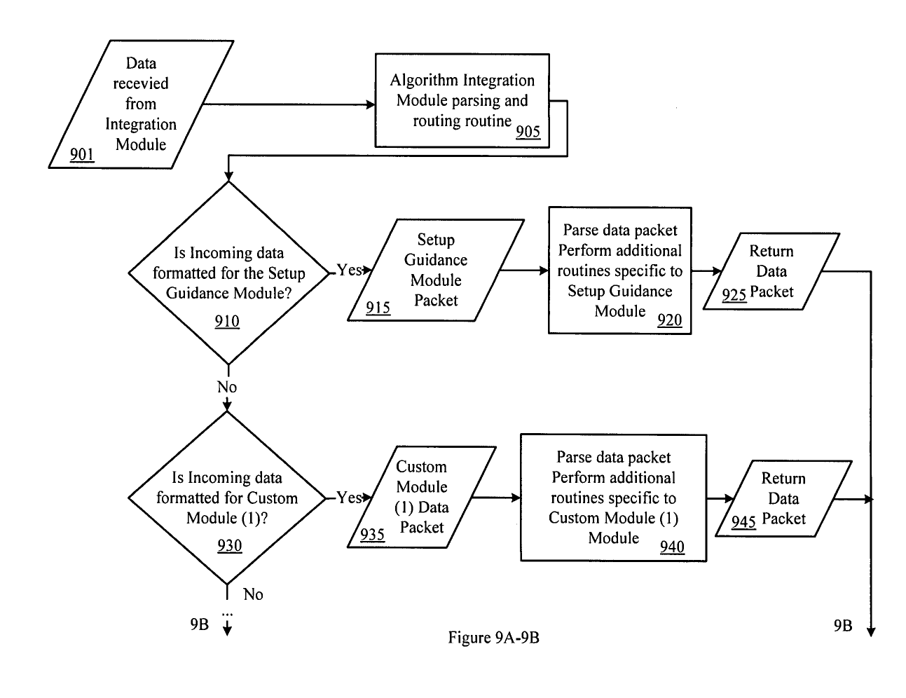

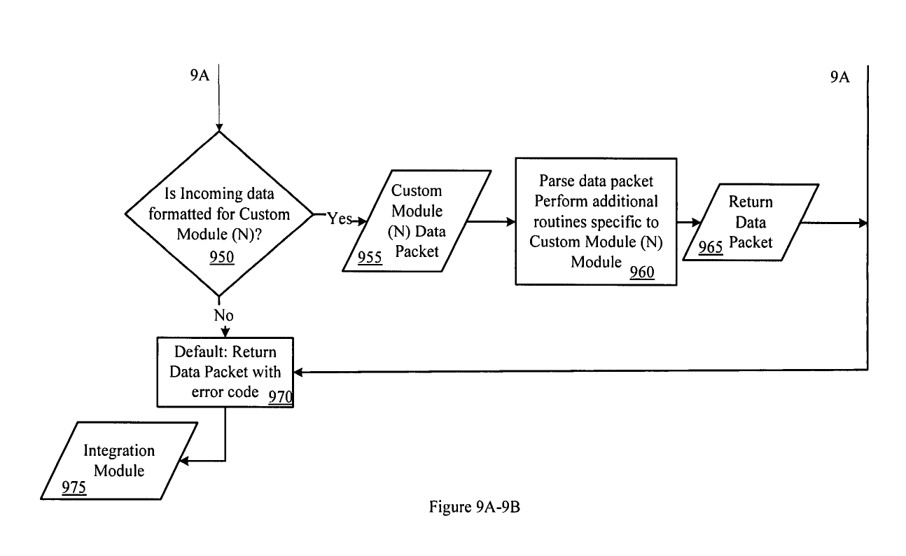

FIGS. 9A-9B are flow charts (900) of operations performed by the algorithm integration module. The method 900 proceeds to the next block 901, which include one or more operations for receiving data from the integrations module. The method 900 proceeds to the next block 905, which include one or more operations for parsing and routing routines from the algorithm integration module. The method 900 proceeds to the next block 910, which include one or more operations for determining if incoming data is properly formatted for the setup guidance module. The method 900 proceeds to the next block 915, which include one or more operations for receiving set-up guidance module packets. The method 900 proceeds to the next block 920, which include one or more operations for parsing data packets, by performing additional routines specific to setup guidance module. The method 900 proceeds to the next block 925, which include one or more operations for receiving return data packets. The method 900 proceeds to the next block 930, which include one or more operations for determining if incoming data is properly formatted for custom module (1). The method 900 proceeds to the next block 935, which include one or more operations for determining custom module data packets. The method 900 proceeds to the next block 940, which include one or more operations for parsing data packets by performing additional routines specific to custom module (1). The method 900 proceeds to the next block 945, which include one or more operations for receiving return data packets. The method 900 proceeds to the next block 950, which include one or more operations for determining if incoming data is properly formatted for custom module (N). The method 900 proceeds to the next block 955, which include one or more operations for determining custom Module (N) data packets. The method 900 proceeds to the next block 960, which include one or more operations for parsing data packets by performing additional routines specific to custom module (N). The method 900 proceeds to the next block 965, which include one or more operations for receiving return data packets. The method 900 proceeds to the next block 970, which include one or more operations for executing a default, by sending a return data packet with an error code. The method 900 proceeds to the next block 975, which include one or more additional operations of the integration module.

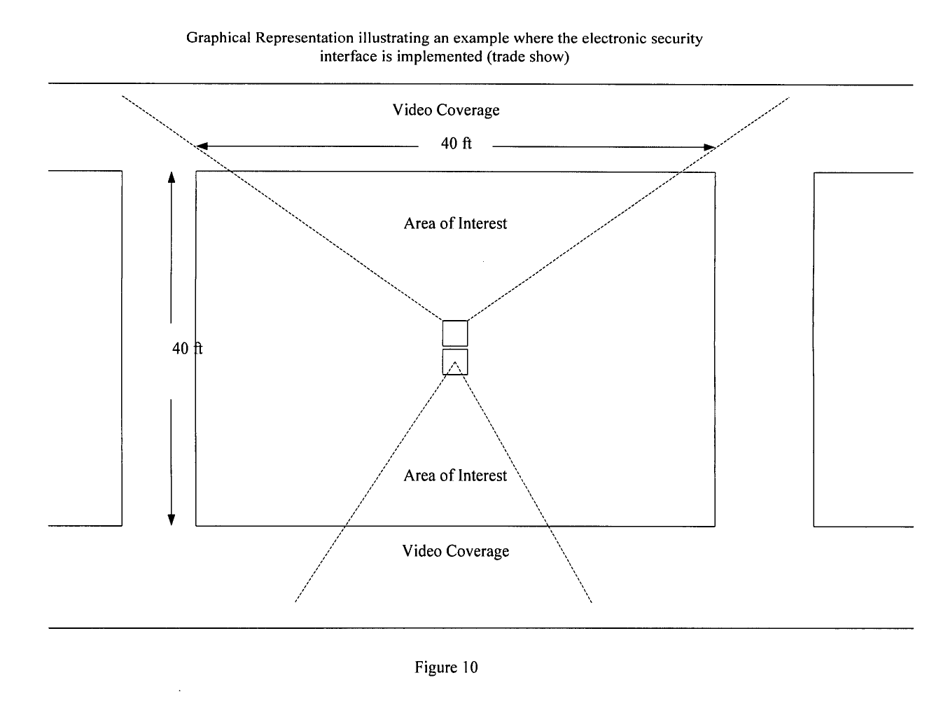

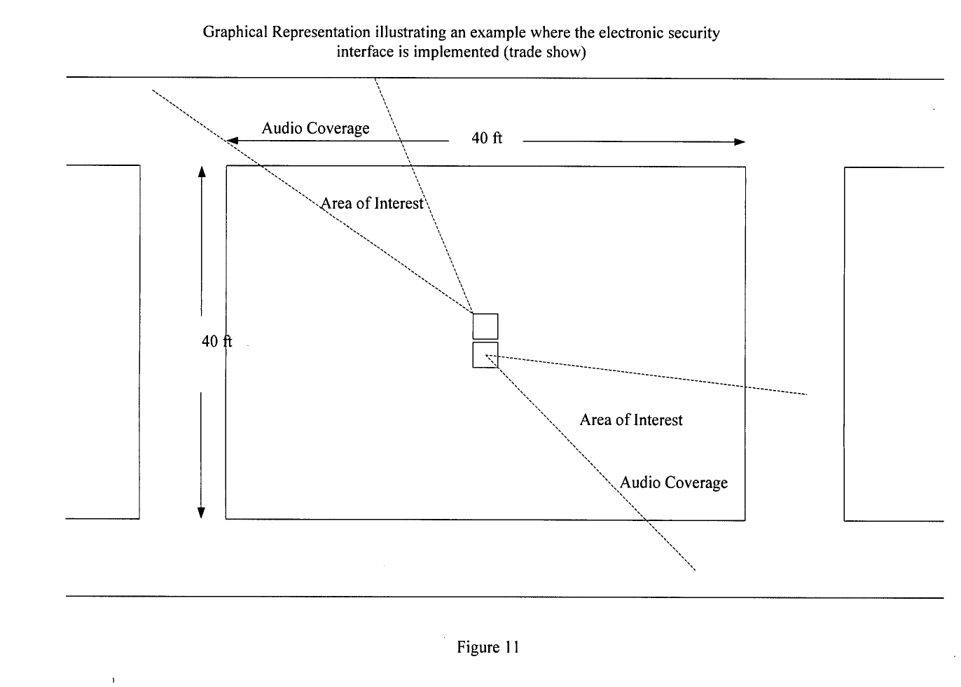

FIGS. 10 and 11 illustrate one example scenario or application, at a trade show. Typically, at trade shows around the world, leads to prospective business are typically generated via personal contacts, for instance, leads are either captured via a barcode reader, RFID device, or hand written with information from a business card supplied by a visitor to an exhibitor at the exhibitor's booth in the trade show. Conversations take place at these events, typically while trying to engage a visitor during the trade show. Important points shared during these conversations are either recorded on paper, or a person must rely on his or her memory to recall and report later. Clearly, important aspects of the conversations are missed as recollections fade with time. Moreover, the body language of a visitor, often providing significant data to the exhibitor, is completely missed. Monitoring systems that can relay images, either static or dynamic, would be advantageous in this scenario.

Another point to consider in the trade show scenario is that some visitors to the trade show are pressed for time, with little or no time to meet all the exhibitors of interest. Most of the time, visitor's schedules are fluid, thereby making it rather difficult to set concrete meeting times. As certain visitors may be critical to an exhibitor, coordinating a meeting is often via email or text, using a mobile communications channel, which is hardly certain to result in a desired meeting. Yet another consideration is that costs to attend trade shows have risen in the past decade and even though selling through the web has increased, most still perceive trade shows as a venue to directly interact with the end customer. Salespeople and marketing personnel typically man the booths, and management of manufacturing or service entities depends on these representatives to bring back their views of success on such trade shows. The management often does not get to “feel” the environment nor does it receive real input from an entity's target customers. For this example application illustrated in FIG. 10, the “automatically configurable and re-configurable security interface” unit is referred to as a “video cube,” which is configured to incorporate all the required external hardware.

Referring also to FIGS. 4 and 5, the unit is configured and scaled to the application requirements depending upon the size of the booth and also what areas or products need to be monitored. As should be recognized, a smaller booth may require a single unit while a larger booth may require two or more units to effectively monitor the entire area. The camera is configured for desired resolution, recording times, storage, email, and text configurations for alarms. The area of focus may be set or changed at a later time or date. The focus has options for more facial, product-related or specific areas of the booth. Placement of cameras at strategic locations is critical for successful video and audio capture. The “video cube” may include a variety of different mechanical mounts, so that it may be easily configured to fix to a booth frame, mounted flush on the wall or hung from the top of the wall, depending on the height, or just mounted on a tripod. The “video cube” may either be plugged into a 110 to 220 volt outlet or operated using the battery pack. In this particular implementation, depending on the booth structure and the location of the products, there are two basic ways to setup and record the audio. An external microphone may be used and mounted on the “video cube,” with it being self-sustaining. The other option is a lavalier microphone, a small dynamic microphone typically used in television, theatre, and public-speaking applications, which allows for hands-free operation. Typically, they are attached with small clips to collars, ties, or other clothing of the persons demonstrating the products and the base unit is attached to the video cube.

The “video cube” configuration may be operated in a couple of different ways. As there are different hours of operation for trade shows, the “video cube” may be programmed for these specific hours of operation or it may also operate by a facial-recognition trigger mode. In this mode, the “video cube” configuration compares the previously downloaded picture from a database of persons of interest. This database may be user created and have information to identify, target, classify and categorize a particular person of interest. The pictures are downloaded from a public source or created using a physical camera. In real-time, the “video cube” compares the two pictures and only starts recording upon noting a person of interest.

As there is no requirement to connect the “video cube” to an external computer, the unit is started using a standard web browser and remotely logs in to the “video cube” either via a cellular network or WiFi connection. Settings for the “video cube” may be changed remotely using the web browser.

Once the “video cube” is setup to record, automatic alarms (as configured in the initial setup) are triggered and the messages either go out via the cellular or WiFi link. The entire recording is stored in the unit and downloaded offline to a website or computer. Video and audio streams are sent in real-time via the cellular or WiFi links. A compression algorithm is used to minimize the required bandwidth. After editing the audio and video streams, excerpts are converted to a more generic form like YouTube etc.

In the preceding description, for purposes of explanation, numerous specific details are indicated in order to provide a thorough understanding of the technology described. It should be apparent, however, that this technology may be practiced without these specific details. In other instances, structures and devices are shown in block diagram form in order to avoid obscuring the technology. For example, the present technology is described with some embodiments below with reference to user interfaces and particular hardware. However, the present technology applies to any type of computing device that may receive data and commands, and any devices providing services. Moreover, the present technology is described above primarily in the context of security applications, however, it should be understood that the present technology may deviate from the embodiments disclosed for this purpose.

Reference in the specification to “one embodiment or implementation,” “an embodiment or implementation,” or “some embodiments or implementation” means simply that one or more particular features, structures, or characteristics described in connection with the one or more embodiments or implementations is included in at least one or more embodiments or implementations that are described. The appearances of the phrase “in one embodiment or implementation” in various places in the specification are not necessarily all referring to the same embodiment or implementation.

Some portions of the detailed descriptions above are presented in terms of algorithms and symbolic representations of operations on data bits within a computer memory of either one or more computing devices. These algorithmic descriptions and representations are the means used by those skilled in the data processing arts to most effectively convey the substance of their work to others skilled in the art. An algorithm as indicated here, and generally, is conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the following discussion, it should be appreciated that throughout the description, discussions utilizing terms such as “processing,” “computing,” “calculating,” “determining,” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present technology also relates to an apparatus for performing the operations described here. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

This technology may take the form of an entirely hardware embodiment, an entirely software embodiment, or an embodiment including both hardware and software components. In some embodiments, this technology is implemented in software, which includes but is not limited to firmware, resident software, microcode, etc.

Furthermore, one or more components of this technology or this technology as a whole may take the form of a computer program product accessible from a computer-usable or computer-readable medium providing program code for use by or in connection with a computer or any instruction execution system. For the purposes of this description, a computer-usable or computer-readable medium may be any apparatus that can include, store, communicate, propagate, or transport the program for use by or in connection with the instruction execution system, apparatus, or device.

A data processing system suitable for storing and/or executing program code includes at least one processor coupled directly or indirectly to memory elements through a system bus. The memory elements may include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Communication units including network adapters may also be coupled to the systems to enable them to couple to other data processing systems, remote printers, or storage devices, through either intervening private or public networks. Modems, cable modems, and Ethernet cards are just a few examples of the currently available types of network adapters.

Finally, the algorithms and displays presented in this application are not inherently related to any particular computer or other apparatus. Various general-purpose systems may be used with programs in accordance with the teachings here, or it may prove convenient to construct more specialized apparatus to perform the required method steps. The required structure for a variety of these systems is outlined in the description below. In addition, the present technology is not described with reference to any particular programming language. It should be understood that a variety of programming languages may be used to implement the technology as described here.

The foregoing description of the embodiments or implementations of the present technology has been presented for the purposes of illustration and description. It is not intended to be exhaustive nor limit the present technology to the precise forms disclosed. Many modifications and variations are possible in light of the above teaching. It is intended that the scope of the present technology be limited not by this detailed description, but rather by the claims of this application. As should be understood by those familiar with the art, the present technology may be embodied in other specific forms, without departing from the spirit or essential characteristics thereof. Likewise, the particular naming and division of the modules, routines, features, attributes, methodologies, and other aspects are not mandatory or significant, and the mechanisms that implement the present disclosure or its features may have different names, divisions and/or formats. Furthermore, as should be apparent to one of ordinary skill in the relevant art, the modules, routines, features, attributes, methodologies and other aspects of the present technology may be implemented as software, hardware, firmware, or any combination of the three. Also, wherever a component, an example of which is a module, of the present technology is implemented as software, the component may be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present technology is in no way limited to implementation in any specific programming language, or for any specific operating system or environment. Accordingly, the disclosure of the present technology is intended to be illustrative, but not limiting, of the scope of the present disclosure, which is set forth in the following claims.

What is claimed is:

1. A method of configuring a system for monitoring a location:
determining, using at least one computing device, parameters of the location;
classifying the parameters, wherein the parameters define requirements for at least one or more of audio, video, communication, storage, recording times, and energy devices;
cross-reference the parameters with a predefined database of hardware devices to selectively determine suggested hardware devices that meet the requirements;
suggest software configurations based on the requirements; and
enable user access to software configurations and the hardware devices that meet the requirements, to enable modifications to either the hardware devices and the software configurations.

2. A method of claim 1, wherein the requirements are scalable.

3. A method of claim 1, wherein depending on the requirements, the suggested hardware devices are a subset of all available devices possible.

4. A method of claim 1, wherein new hardware devices are automatically discovered and added to the predefined database.

5. A method of claim 1, wherein a device that is determined to be obsolete is automatically deleted from the predefine database.

6. A method of claim 1, wherein a user is provided access to the at least one computing device, from at least one of a desktop, a laptop computer, a mobile device interface, an application programming interface (API), a software development kit (SDK), web services and a tablet software interface.

7. A method of claim 1, wherein the at least one computing device includes a computer readable storage medium to store and retrieve information.

8. A method of claim 1, wherein a user can input a new device in the predefined database using a development kit.

9. A system, comprising:
a set of devices for security monitoring, dynamically configurable for different applications and scales, further comprising:
one or more video cameras configured to capture images of designated areas or entities;
an audio input and output to interface to a microphone to capture and reproduce sounds of the designated areas or entities;
communications devices including at least one or more of a group of WiFi, Cellular, Zigbee, Near Field Communication (NFC), Radio Frequency Identification (RFID) wired and wireless routers, configured to transfer information from the system to a user or to other external systems and external users;
a battery unit configured to drive the system when power from an outlet is not available;
a barcode reader to receive input from a user; and
a storage device to record images and sounds and store device configurations.

10. A system according to claim 9, wherein a single audio input is configured to accept a plurality of sources, wired or wireless microphones, interface via a serial interface (USB, I2S, SPI) to a computer for programming the audio parameters, provide a high gain amplifier and record to a computer readable storage medium.

11. A system according to claim 9, wherein a single battery charging unit is configured to accept a plurality of battery types (Li-ion, Li-polymer, LiFePO4, NiMH, NiCD and lead acid) from a single interface.

12. A system according to claim 9, wherein the battery unit is configured to program different parameters using a serial (USB, I2S, SPI) interface to a computer.

13. A system according to claim 9, wherein the battery unit is configured to sense the correct battery type and load the correct program to charge the battery.
